(19) United States
(12) Patent Application Publication
(10) Pub. No.: US 2004/0230759 A1
(43) Pub. Date: Nov. 18, 2004

(54) Synchronous memory system and also method and protocol for communication in a synchronous memory system

(76) Inventors: Georg Braun, Holzkirchen (DE); Andreas Jakobs, Munchen (DE)

Correspondence Address: GERO G. MCCLELLAN, MOSER, PATTERSON & SHERIDAN, L.L.P., Suite 1500, 3040 Post Oak Blvd., Houston, TX, 77056, US

(21) Appl. No.: 10/783,376

(22) Filed: Feb. 20, 2004

(30) Foreign Application Priority Data
Feb. 21, 2003 (DE) 103 07 548.8-53

(51) Int. Cl. G06F 12/00

(52) U.S. Cl. 711/167; 711/105

(57) ABSTRACT

A method, system and protocol for a synchronous memory system. One embodiment of a system comprises: a memory control device; one or more memory modules in a main memory, with each memory module comprising one or more memory banks; a transfer bus for communication between the memory control device and the memory modules, where the transfer bus is in the form of a concatenated bus structure and comprises a plurality of parallel transfer lines; and where the memory control device is designed to generate commands comprising a plurality of command segments with a respective plurality of elements, and to transfer them to the memory modules using the transfer bus. The transfer bus is configured to transfer the elements of a command segment in parallel, and the commands each comprise a selection command segment for selecting one or more memory banks, with each of the memory banks having at least one uniquely associated element of the selection command segment.

### CROSS-REFERENCE TO RELATED APPLICATIONS

This application claims foreign priority benefits under 35 U.S.C. §119 to co-pending German patent application number 103 07 548.8-53, filed Feb. 21, 2003. This related patent application is herein incorporated by reference in its entirety.

### BACKGROUND OF THE INVENTION

1. Field of the Invention

The present invention relates to a synchronous memory system, a method for communication in a synchronous memory system and a protocol for communication in a synchronous memory system.

2. Description of the Related Art

Synchronous memory systems are known in which a plurality of memory modules are connected to a controller or a memory control device by means of a “stub bus” (particularly in the case of PC100, DDR or DDR-II). The stub bus is in the form of a parallel transfer line from which connections branch to the individual memory modules. Particularly in high frequency ranges or for high data rates, such an arrangement has the drawback that reflections occur in the memory banks in the memory modules and impair the signal on the bus. Particularly at data rates of 800 Mbps/pin and above (megabits per second and per pin), the known designs reach their limits.

### SUMMARY OF THE INVENTION

It is thus an object of the present invention to provide a synchronous memory system, a method for communication in a synchronous memory system and a protocol for communication in a synchronous memory system which allow fast and secure transfer of signals within the memory system, particularly at high data rates.

This object is achieved by a synchronous memory system having the features specified in claim 1, a method for communication in a synchronous memory system having the features specified in claim 16, and a protocol for communication in a synchronous memory system having the features specified in claim 22. Preferred embodiments are covered by the dependent claims.

The invention provides a synchronous memory system comprising: a memory control device; one or more memory modules in a main memory, with each memory module comprising one or more memory banks; and a transfer bus for communication between the memory control device and the memory modules, where the transfer bus is in the form of a concatenated bus structure or “daisy chain” structure and comprises a plurality of parallel transfer lines. The memory control device is configured to generate commands, which comprise a plurality of command segments with a respective plurality of elements, and to transfer them to the memory modules using the transfer bus. The transfer bus is configured to transfer the elements of a command segment in parallel, and the commands each comprise a selection command segment or memory bank selection vector for selecting one or more memory banks, with each of the memory banks having at least one uniquely associated element of the selection command segment.

Within the context of this invention, a memory bank is understood to mean an array of memory chips which are all addressed essentially simultaneously or together using the same command (incl. the chip select signal). This is advantageous for the purpose of, by way of example, equipping a memory data bus, for example comprising 64 bits, with four memory chips which, for their part, provide only 16 data bits.

Preferably, the synchronous memory system comprises at least two memory banks.

In the concatenated bus structure, point-to-point connections (P2P connections) or links are preferably provided between the memory control device and the memory modules and between the memory modules themselves. In this context, a first memory module is connected to the memory control device by means of a point-to-point connection and to the adjacent memory module by means of a further point-to-point connection. The further memory modules are likewise connected to the respective next memory module by means of point-to-point connections.

Each memory bank has at least one dedicated element provided for it in the selection command segment. This allows each memory bank to be addressed directly. Hence, one, a plurality or all of the memory banks can be addressed simultaneously.

The main memory is preferably a DIMM store (Dual In-line Memory Module store) as used in conventional computers.

Preferably, the memory modules also comprise a buffer device or a buffer chip for forwarding commands to one or more memory banks in a respective memory module and/or to other memory modules. The buffer device forms an interface between the memory banks and the transfer bus.

Preferably, the buffer device is designed to compare the bit pattern of a command's selection command segment with one or more predetermined bit patterns and to decide whether the associated command needs to be forwarded to one or more of the memory banks in the memory module and/or to other memory modules.

The buffer device thus preferably comprises a switch or a comparison device which can be used to ascertain whether a command needs to be forwarded to one or more of the memory banks in the respective memory module. It is also possible to decide whether a command needs to be transferred to the adjacent memory module, which is connected to the memory module by means of the transfer bus.

In addition, the buffer device is preferably designed to generate a chip select signal for one or more memory banks. The chip select signal or memory-bank select signal is used to signal to the respective memory bank that the respective command is intended for it.

Preferably, the selection command segment is the first segment of a command. It is thus possible to ascertain very early whether or not the respective command is intended for a memory bank in a respective memory module. This allows latency or delays in the system to be kept low.

Preferably, the number of transfer lines in the transfer bus is at least equal to the maximum number of memory banks which can be used in the memory system.

In addition, the commands for each memory bank can contain an element for a clock enable signal or timer activation signal. This means that the commands contain at least as many elements for a clock enable signal as there are memory banks which are or can be used in the system. The individual clock enable signals can thus each be assigned to a particular memory bank.

Alternatively, the commands can contain an element for a clock enable signal for all the memory banks. This means that just one element per command is provided for a clock enable signal. The selection command segment can be used to ascertain for which memory bank or which memory banks the clock enable signal is provided in the respective case.

In a similar manner to the clock enable signal, the commands for each memory bank can contain an element for an on-die termination signal. It is thus possible to assign each memory bank a dedicated on-die termination signal. Alternatively, the commands can contain an element for an on-die termination signal for all the memory banks. Hence, just one element per command is provided for an on-die termination signal.

In addition, the buffer device can be designed to generate an on-die termination signal. The on-die termination signal is thus no longer contained in the commands, but rather is generated internally in the memory module by the buffer device.

Preferably, the commands contain an element for a reset signal. Alternatively, a transfer line for a reset signal can be provided in the system.

Preferably the commands contain an element for signaling that the command is intended for the buffer device. This means that commands can be addressed not only to the memory banks but also to the buffer device. In addition, provision can be made for a few elements of a command to be given a different function if the command is intended for the buffer device.

With further preference, the memory control device comprises a coding device for coding generated commands and the buffer device contains a decoding device for decoding received coded commands.

As a result of the generated commands being coded, in particular, using a coding method for high-speed transfer, it is possible to transfer the commands at high speed.

The invention also provides a method for communication in a synchronous memory system, particularly according to the invention or a preferred embodiment thereof, between a memory control device and one or more memory modules in a main memory using a transfer bus, where each memory module comprises one or more memory banks and where the transfer bus is in the form of a concatenated bus structure and comprises a plurality of parallel transfer lines. The method comprises the following steps. Commands which comprise a respective plurality of command segments with a respective plurality of elements are generated by the memory control device. The commands are transmitted to the memory modules using the transfer bus, with the elements of a command segment being transferred in parallel. Where the commands comprise a selection command segment for selecting one or more memory banks, with each of the memory banks having at least one uniquely associated element of the selection command segment.

Preferably, the memory modules each comprise a buffer device and the method comprises the following steps: the commands are received from the transfer bus by the buffer device; and the commands are forwarded to one or more memory banks in a respective memory module and/or to other memory modules by the buffer device.

Preferably, the method comprises the following steps: the bit pattern of the selection command segment is compared with one or more predetermined bit patterns by the buffer device; and the buffer device decides whether the associated command needs to be forwarded to one or more of the memory banks in the memory module and/or to other memory modules.

Preferably, the method also comprises a step in which a chip select signal is generated for one or more memory banks by the buffer device. With further preference, the selection command segment is transferred as the first segment of a command.

Preferably, the method also has a step in which generated commands are coded by the memory control device, and a step in which the received coded command is decoded by the buffer device.

The invention also provides a protocol for communication in a synchronous memory system, particularly according to the invention or a preferred embodiment thereof, between a memory control device and one or more memory modules in a main memory using a transfer bus, where each memory module comprises one or more memory banks and the transfer bus is in the form of a concatenated bus structure and comprises a plurality of parallel transfer lines, where the protocol comprises commands which have a plurality of command segments with a respective plurality of elements and the commands comprise a selection command segment for selecting one or more memory banks, with each of the memory banks having at least one uniquely associated element of the selection command segment.

The above description of the system also applies accordingly to the method and the protocol.

### BRIEF DESCRIPTION OF THE DRAWINGS

The invention is described by way of example below with reference to accompanying drawings of preferred embodiments, where:

FIG. 1 shows a schematic block diagram of a fundamental part of a system in line with a preferred embodiment of the present invention;

FIG. 2 shows a detailed view of the system from FIG. 1;

FIG. 3 shows an illustration of a command for a system according to a first preferred embodiment of the invention;

FIG. 4 shows an illustration of a command for a system according to a second preferred embodiment of the invention; and

FIG. 5 shows an illustration of a command for a system according to a third preferred embodiment of the invention.

### DETAILED DESCRIPTION OF THE PREFERRED EMBODIMENT

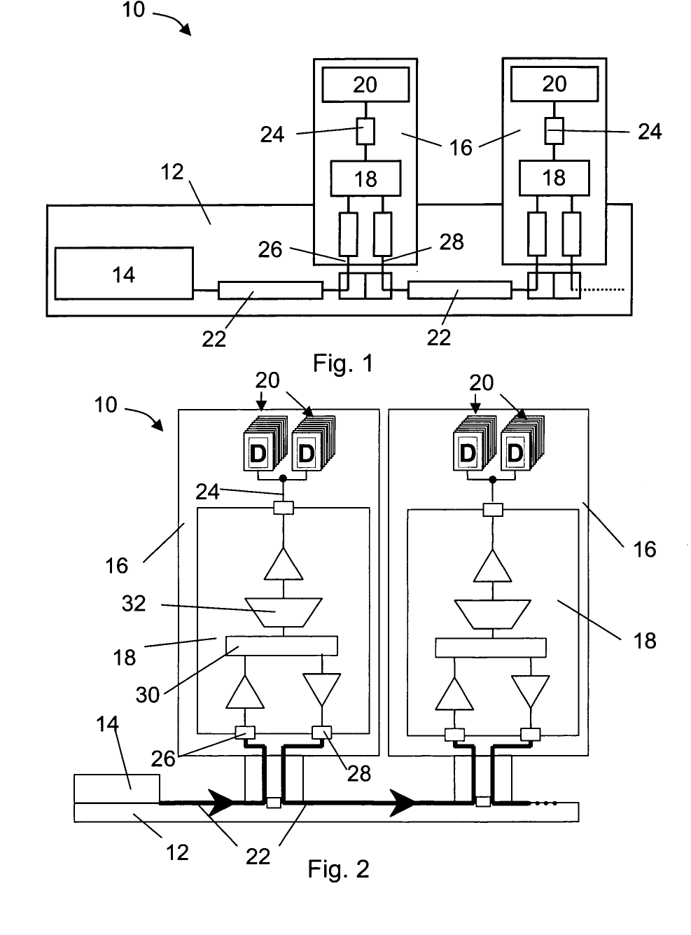

The text below describes a preferred embodiment of a system based on the invention with reference to FIGS. 1 and 2.

FIG. 1 shows a schematic block diagram of part of a system 10 based on a preferred embodiment of the present invention, and FIG. 2 shows a detailed view of the system 10 from FIG. 1.

The synchronous memory system 10 comprises a “motherboard” 12 on which a memory control device or controller 14 and one or more memory modules 16 are arranged. FIG. 1 and FIG. 2 each show only two memory modules 16.

The memory control device 14 sends data and commands to the memory modules 16. The memory modules 16 can be, by way of example, DIMMs (Dual In-Line Memory Modules) in a (conventional) computer and can form the main memory of the computer. A memory module 16 comprises a buffer device 18 and one or more memory banks 20.

As already explained, a memory bank 20 within the context of the invention is understood to mean an array of memory chips D which are all addressed essentially simultaneously or together using the same commands. In this context, the chip select signal is also the same for all the memory chips D in a memory bank 20. By way of example, a memory data bus comprising 64 bits is equipped with four memory chips D each of which provide only 16 data bits. The memory chips D can be DRAMs, for example. Preferably, n memory banks 20 are provided, or n memory banks 20 can be used in the system 10.

The buffer device 18 receives commands from the memory control device 14 and forwards them to the memory banks 20 and/or adjacent memory modules 16. The buffer device 18 comprises an input connection 26 for receiving commands or signals and an output connection 28 for outputting commands or signals. In addition, the buffer device 18 contains a switch 30 and a DM or demultiplexer circuit 32. The DM 32 converts the fast, narrow transfer bus 22 into a slower, broad or broader bus for the memory chips. The way in which the switch 30 works is described later.

The memory control device 14 and the memory modules 16 are connected to one another by means of a transfer bus or CA link 22. In this context, the transfer bus 22 is in the form of a concatenated bus structure or forms a “daisy chain” structure. This means that the memory control device 14 is connected directly to a first memory module 16 by means of a point-to-point connection or link. The first memory module 16 is connected to the adjacent memory module 16 likewise by means of a point-to-point connection or link. The subsequent memory modules 16 (not shown in FIGS. 1 and 2) are likewise connected to one another in concatenated fashion by means of point-to-point connections or links. The memory modules 16 thus form a chain in which a respective memory module 16 is always connected to the next one. Provision can also be made for the last memory module 16 in the chain to be connected to the memory control device 14. This is not the case in the embodiment shown here, however.

The transfer bus 22 has a plurality of parallel transfer lines or CA lines which can be used to transfer command parts (described later) simultaneously or in parallel. In this context, the number of parallel transfer lines corresponds to the maximum number of memory banks 20 which can be used in the memory system 10. There are thus preferably n transfer lines in the transfer bus 22. A larger or smaller number of parallel transfer lines may also be provided, however. In addition, there may also be further transfer lines, for example for transferring synchronisation signals such as clock signals or strobe signals.

In each memory module 16, the buffer device 18 is connected to the memory banks 20 by means of internal connections 24. The internal connections 24 likewise have parallel transfer lines or CA lines, with the number of transfer lines in the internal connections 24 being greater than the number of transfer lines in the transfer bus 22.

The number of pins or connections which is required to connect a memory module 16 to the transfer bus 22 corresponds to the number of transfer lines in the transfer bus 22 and can thus be kept low.

The memory control device 14 communicates with the memory modules 16 using commands. These commands are transferred from the memory control device 14 to the memory modules 16 using a protocol which uses commands in a particular format.

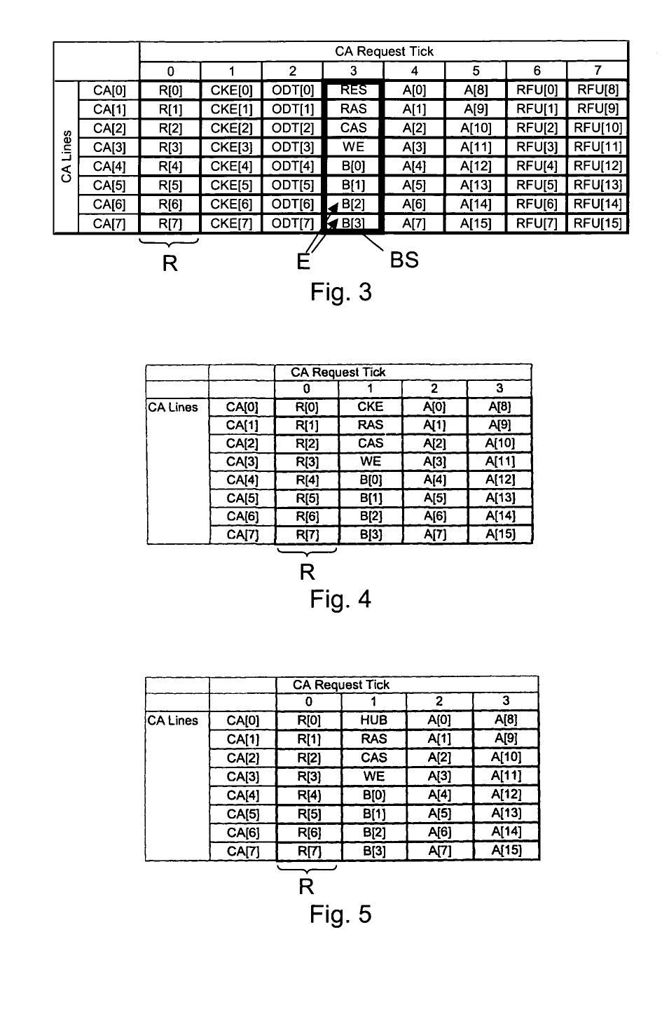

The text below describes a first command format, used in a synchronous memory system based on the preferred embodiment of the present invention, with reference to FIG. 3.

A command comprises a plurality of command segments BS which each have a plurality of elements or bits E. The number of elements E per command segment BS is preferably equal to the number n of parallel transfer lines in the transfer bus 22. In the embodiment illustrated, n is equal to 8, for example. Any other suitable number may be provided, however. The transfer lines in the transfer bus 22 are denoted by CA[0] to CA[7] in FIG. 3.

The elements E of a command segment BS are transferred simultaneously or in parallel via the transfer bus 22. A command may also be regarded as a matrix of signals, with the command segments BS corresponding to the columns in the matrix.

In line with the preferred embodiment of the invention, each command comprises a selection command segment or memory bank selection vector R. A respective element or bit R[i] of the selection command segment R is associated with a predetermined memory bank 20. Using the elements R[i] in the selection command segment R, it is possible to select or address individual, a plurality of or all memory banks 20. This means that the respective command is intended for the selected memory bank 20 or for the selected memory banks 20. If the element or bit R[i] has been set, the i^{th} memory bank 20 is thus selected and the command is intended for this memory bank. In the selection command segment R, none, one, a plurality or all of the elements can be set in order to select none, one, a plurality or all of the memory banks 20.

The individual memory banks 20 are thus addressed directly using the elements E of the selection command segment R without any coding taking place. It is thus a simple matter to add memory modules 16 as part of the capacity of the memory system 10. In addition, as already discussed above, it is possible to send a command (“broadcast command”) to a plurality or all of the memory banks 20 simultaneously.

A command in line with the first embodiment also preferably comprises a command segment BS whose elements E are clock enable signals or timer activation signals CKE. In this context, each memory bank 20 which is to be addressed separately in the memory system 10 has a dedicated CKE element CKE[i] associated with it.

In addition, a command in line with the first embodiment may comprise a command segment BS whose elements E are on-die termination signals ODT. In this context, each memory bank 20 which is intended to be addressed separately in the memory system 10 likewise has a dedicated ODT element or ODT bit ODT[i] associated with it.

In addition, a command in line with the first embodiment can contain elements or bits for a reset signal RES, a row-address strobe signal RAS, a column-address strobe signal CAS, a write enable signal WE, bank signals B[i], address signals A[i] and other signals RFU[i] not specified in more detail. The signals RAS, CAS and WE are used for command coding.

The text below describes the operation of a preferred synchronous memory system 10 with reference to the figures.

The memory control device 14 generates a command and forwards this command to the first memory module 16 via the transfer bus 22. In this context, the individual command segments BS of the command are transferred in succession, with a command segment BS being transferred per clock cycle or CA request tick. Transferring a command in full requires as many clock cycles as there are command segments BS per command.

In one preferred embodiment, the generated command is also coded using a coding method prior to transfer. Such a coding method may be, by way of example, the code 8B10B, which is used for high-speed network connections. It is likewise possible to use any other suitable coding method, however. To this end, the memory control device 14 preferably contains a coding device.

The processing of the uncoded commands by the memory control device 14 and the buffer device 18 can thus be regarded as a “logical protocol”. By contrast, the processing of the coded commands can be regarded as an “electrical or physical protocol”, with the “logical protocol” and the “physical protocol” being able to differ from one another.

The buffer device 18 in the first memory module 16 receives the command and compares the bit pattern in the selection command segment R with an internal predetermined bit pattern.

If the commands have been coded by the memory control device 14 prior to transfer, the received commands are first decoded via the buffer device 18 following reception. To this end, the buffer device 18 preferably contains a decoding device.

According to the comparison result, the buffer device 18 forwards the command to one, a plurality or all of the memory banks 20 in the memory module 16 and/or forwards the command to the next memory module 16 in the chain. That is to say that, if the comparison has ascertained that the command is intended for one or more memory banks 20 in the memory module 16, the command is forwarded to the respective memory banks 20. At the same time, the command is forwarded to the next or adjacent memory module 16. If the comparison has ascertained that the command is not intended for the memory banks 20 in the memory module 16, the command is forwarded to the next or adjacent memory module 16 only.

In the next memory module 16, the buffer device 18 receives the forwarded command and again performs a comparison. This is carried out up to the last memory module 16 in the chain.

Preferably, the buffer device 18 can have a functionality which can be used to ascertain whether or not the command is intended for the subsequent memory modules 16. If the command is not intended for the subsequent memory modules 16, the buffer device 18 forwards the command to the associated selected memory banks 20 only and not to the subsequent memory module 16. The fact that commands are forwarded only if they are intended for the subsequent memory modules 16 means that it is possible to achieve a power saving in the memory system 10.

Provision may also be made for the command not to be forwarded if the buffer device 18 ascertains that it is the last in the memory system 10.

Preferably, the selection command segment R is transferred as the first segment of a command. This allows the above decision in the buffer device 18 to be made early, and latencies in the buffer device 18 can be kept low.

In addition, provision can be made for the buffer device 18 to generate the chip select signal, i.e. the signal which signals to the memory bank 20 that the command is intended for it, internally for the respective memory bank 20.

The text below describes a second command format, which can be used in a synchronous memory system in line with the preferred embodiment of the present invention, with reference to FIG. 4.

The second command format essentially corresponds to the first command format. The text below therefore points out only the differences from the first command format.

In a second command format, just one element for a clock enable signal CKE is provided per command. The selection command segment is used for actually stipulating those memory banks 20 for which the command is intended. This means that a separate clock enable signal CKE for each individual memory bank 20 is no longer required.

In addition, the on-die termination signal ODT for the memory banks 20 is generated internally by the buffer device 18. From the transferred commands for the dedicated and other memory banks 20, the respective buffer device 18 is able to establish when activation of the on-die termination is required. It is thus not necessary to provide an element for an on-die termination signal ODT in the commands.

The reset signal RES is supplied to the memory modules 16 using a dedicated line provided in addition to the transfer bus 22. This is possible because the reset signal RES is required only rarely and usually asynchronously, i.e. without any temporal relationship with the commands.

Hence, in comparison with the first command format, fewer elements E or command segments BS are required per command. The commands are thus shorter, i.e. they have fewer command segments BS, and can be transferred more quickly, since fewer clock cycles are required.

The text below describes a third command format, which can be used in a synchronous memory system in line with the preferred embodiment of the present invention, with reference to FIG. 5.

The third command format essentially corresponds to the second command format. The text below therefore points out only the differences from the first command format.

Instead of the reset signal RES, a HUB signal is used which signals when a command is not intended for one or more memory banks 20 but rather for the buffer device 18 itself. In this context, the buffer device 18 preferably comprises configuration registers which can be set using the HUB signal. This allows the functionality of individual elements E to be altered. By way of example, the HUB signal can be used to assign a different meaning to the signals RAS, CAS, WE, B[i] and A[i] when the HUB signal assumes a predetermined value. In this case, the memory chip functions, such as power down or self-refresh, can be controlled by the buffer device commands. Provision can also be made for the buffer device 18 to have its own power-down mode. This mode can be activated automatically when the downstream memory chips are put into the power-down state or self-refresh state.

The synchronous memory system described above can be operated for high data rates, particularly DDR III (Double Data Rate III) at 1066-1333 Mbps/pin).

What is claimed is:

1. A synchronous memory system, comprising:
one or more memory modules in a main memory, with each memory module comprising one or more memory banks;
a memory control device configured to generate commands comprising a plurality of command segments with a respective plurality of elements, wherein one of the command segments is a selection command segment for selecting one or more memory banks, and wherein each of the memory banks has at least one uniquely associated element of the selection command segment; and
a transfer bus for communication between the memory control device and the memory modules, wherein the transfer bus is in the form of a concatenated bus structure and comprises a plurality of parallel transfer lines; and wherein the memory control device is configured to transfer the commands to the memory modules using the transfer bus, and wherein the transfer bus is configured to transfer the elements of a command segment in parallel.

2. The synchronous memory system of claim 1, where the memory modules further comprise a buffer device for forwarding the commands to one or more memory banks in at least one of a respective memory module and one or more other memory modules.

3. The synchronous memory system of claim 2, where the buffer device is configured to compare the bit pattern of a given selection command segment with one or more predetermined bit patterns and to determine whether the associated command needs to be forwarded to at least one of: (i) one or more of the memory banks in the memory module; (ii) and one or more other memory modules.

4. The synchronous memory system of claim 2, wherein the buffer device is configured to generate a chip select signal for one or more memory banks.

5. The synchronous memory system of claim 1, where the selection command segment is the first segment of the commands.

6. The synchronous memory system of claim 1, wherein the number of transfer lines in the transfer bus is at least equal to the maximum number of memory banks which can be used in the memory system.

7. The synchronous memory system of claim 1, wherein the commands for each memory bank contain an element for a clock enable signal.

8. The synchronous memory system of claim 1, wherein the commands contain an element for a clock enable signal for all the memory banks.

9. The synchronous memory system of claim 1, wherein the commands for each memory bank contain an element for an on-die termination signal.

10. The synchronous memory system of claim 1, wherein the commands contain an element for an on-die termination signal for all the memory banks.

11. The synchronous memory system of claim 1, wherein the buffer device is designed to generate an on-die termination signal.

12. The synchronous memory system of claim 1, wherein the commands contain an element for a reset signal.

13. The synchronous memory system of claim 1, further comprising a transfer line connecting the memory control device and at least one of the memory modules and configured to propagate a reset signal.

14. The synchronous memory system of claim 1, wherein the commands contain an element for signaling that the command is intended for the buffer device.

15. Synchronous memory system of claim 1, wherein the memory control device comprises a coding device for coding generated commands and the buffer device comprises a decoding device for decoding received coded commands.

16. A method for communication, in a synchronous memory system, between a memory control device and one or more memory modules in a main memory using a transfer bus, where each memory module comprises one or more memory banks, the transfer bus is in the form of a concatenated bus structure and comprises a plurality of parallel transfer lines, the method comprising:
generating, with the memory control device, commands comprising a respective plurality of command segments with a respective plurality of elements, wherein one of the command segments is a selection command segment for selecting one or more memory banks, and wherein each of the memory banks has at least one uniquely associated element of the selection command segment;
transmitting the commands to the memory modules using the transfer bus, with the plurality of elements being transferred in parallel.

17. The method of claim 16, further comprising:
receiving the commands from the transfer bus by a buffer device; and
forwarding, by the buffer device, the commands to at least one of (i) one or more memory banks in a respective memory module; and (ii) one or more other memory modules.

18. The method of claim 16, further comprising:
receiving the commands from the transfer bus by a buffer device; and
comparing a bit pattern of the respective selection command segments with one or more respective predetermined bit patterns by the buffer device; and
determining, on the basis of the comparison, whether the command needs to be forwarded to at least one of (i) one or more memory banks in a respective memory module; and (ii) one or more other memory modules.

19. The method of claim 16, further comprising:
receiving the commands from the transfer bus by a buffer device; and
comparing a bit pattern of the selection command segment with one or more predetermined bit patterns by the buffer device; and
determining, from the comparison, that the selection command segment is destined for a memory bank associated with the buffer device; and
generating, by the buffer device, a chip select signal for the associated memory bank.

20. The method of claim 16, wherein the selection command segment is transferred as the first segment of a command.

21. The method of claim 16, further comprising:
generating, by the memory control device, coded commands; and
decoding the coded command at the memory modules.

22. A protocol for communication, in a synchronous memory system, between a memory control device and one or more memory modules in a main memory using a transfer bus, where each memory module comprises one or more memory banks and the transfer bus is in the form of a concatenated bus structure and comprises a plurality of parallel transfer lines, the protocol comprising:
commands having a plurality of command segments with a respective plurality of elements and wherein one of the command segments comprises a selection command segment for selecting one or more memory banks, with each of the memory banks having at least one uniquely associated element of the selection command segment.
